(19) United States
(12) Patent Application Publication
(10) Pub. No.: US 2024/0344001 A1
(43) Pub. Date: Oct. 17, 2024

(54) UNIT DOSE DETERGENT COMPOSITION WITH AMINO ACID

(71) Applicant: Henkel AG & Co. KGaA, Duesseldorf (DE)

(72) Inventors: Daniel Thomas Piorkowski, Fairfield, CT (US); Peter Schmiedel, Duesseldorf (DE)

(73) Assignee: Henkel AG & Co. KGaA, Duesseldorf (DE)

(21) Appl. No.: 18/617,223

(22) Filed: Mar. 26, 2024

Related U.S. Application Data
(60) Provisional application No. 63/495,476, filed on Apr. 11, 2023.

(51) Int. Cl. C11D 17/04; C11D 1/29; C11D 1/722; C11D 3/04; C11D 3/30; C11D 3/33; C11D 3/42; C11D 3/43

(52) U.S. Cl. CPC C11D 17/042; C11D 1/29; C11D 1/722; C11D 3/044; C11D 3/30; C11D 3/33; C11D 3/42; C11D 3/43; C11D 2111/12

(57) ABSTRACT

The present disclosure provides a unit dose product comprising a pouch formed from a water-soluble film material; and a detergent composition comprising about 5 to about 20 wt % water, about 35 to about 65 wt % of at least one surfactant, at least one amino acid or a salt thereof, a base, and a non-aqueous solvent, wherein the detergent composition is disposed within the pouch. The composition can further comprise additional components, such as an anti-redeposition agent, an enzyme, a bleaching agent, a bleach activator, a chelating agent, an additional chlorine scavenger, a biocide, an optical brightener, a bitterant, a corrosion inhibitor, or a combination thereof. The detergent composition in the unit dose product can scavenge chlorine to a concentration of 0 ppm in less than about 60 sec after contact with a 1 L water sample comprising up to 4 ppm chlorine.

### BACKGROUND

Municipal water originates from a variety of sources, such as lakes, rivers, reservoirs, and wells. To make the water drinkable, chlorine can be added as a disinfectant. A concentration up to 4 ppm chlorine is typically the maximum allowed in municipal water, as suggested by the Centers for Disease Control and Prevention.

However, chlorine is known to deteriorate a fabric's dye over time, particularly red, blue, or black dyes. If not controlled, this dye deterioration generally will be seen in about 3 to 30 washes. In addition to fabric dye damage, chlorine in the water can negatively impact an enzyme's performance for cleaning soiled laundry. Monoethanolamine can be used in a detergent composition as a pH buffer and a chlorine scavenger. Triethanolamine can be added as a pH buffer. However, these amines are not yet certified as Safer Choice labeling designation by the U.S. Environmental Protection Agency (EPA).

Unit dose detergent products are often found by consumers to be preferable for use in laundry applications. Such unit dose products have several advantages, including convenience of use and dispensing, lower cost per use, and avoiding or minimizing skin contact with potentially irritating cleaning compositions.

Since there is a consumer push for improving detergent sustainability and convenience, there is a need for a unit dose product comprising a detergent composition that can effectively clean textiles while scavenging chlorine to protect fabric dyes and enzyme activity by incorporating more Safer Choice ingredients.

### BRIEF SUMMARY

The present disclosure relates to a unit dose product comprising a pouch formed from a water-soluble film material; and a detergent composition comprising about 5 to about 20 wt % water, about 35 to about 65 wt % of at least one surfactant, at least one amino acid, a base, and a non-aqueous solvent, wherein the detergent composition is disposed within the pouch.

In some aspects, the at least one amino acid is selected from alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, and a combination thereof. In some aspects, the at least one amino acid has a charged side chain or a polar uncharged side chain. In some aspects, the at least one amino acid is lysine, threonine, any salt thereof, or a combination of lysine and threonine including salts thereof.

In some aspects, the at least one surfactant is an anionic surfactant, a cationic surfactant, a zwitterionic surfactant, a nonionic surfactant, or a combination thereof.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. In some aspects, the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or a combination thereof. In some aspects, the zwitterionic surfactant comprises a betaine, a sulfonated quaternary ammonium compound, a phosphonated quaternary ammonium compound, a trialkylamine N-oxide, or a combination thereof. In some aspects, the nonionic surfactant comprises the nonionic surfactant comprises a fatty alcohol alkoxylate, a fatty acid alkoxylate, an alkyl phenol ethoxylate, an alkoxylated amine, an alkyl glucoside, a fatty amide alkoxylate, a diester of alkoxylated fatty acid, an alkoxylated methyl ester of fatty acid, a glycerol fatty ester, castor oil alkoxylate, an ethylene oxide-propylene oxide block copolymer, a phenol alkoxylate, or a combination thereof.

In some aspects, the detergent composition has a pH of of about 6.5 to about 12. In some aspects, the detergent composition has a pH of greater than 7.

In some aspects, the base is a Group I hydroxide, a Group II hydroxide, monocthanolamine, diethanolamine, triethanolamine, methyl diethanolamine, sodium tetraborate, trisodium phosphate, sodium carbonate, or a combination thereof. In other aspects, the base is a Group I hydroxide, a Group II hydroxide, sodium tetraborate, trisodium phosphate, sodium carbonate, or a combination thereof.

In some aspects, the non-aqueous solvent is ethylene glycol, diethylene glycol, tricthylene glycol, diethylene glycol monobutyl ether, propylene glycol, dipropylene glycol, tripropylene glycol, dipropylene glycol monobutyl ether, 1,3-butylene glycol, 1,4-butylene glycol, 1-(1-butoxy-2-propoxy)-2-propanol, 2-methyl-2,4-pentanediol, 1,5-pentanediol, 1,6-hexanediol, polyethylene glycol, glycerin, ethanol, or a combination thereof.

In some aspects, the ethanol can be denatured ethanol, such as, e.g., specially denatured alcohol (SDA) that has been denatured with isopropanol.

In some aspects, the detergent composition further comprises at least one additive selected from an anti-redeposition agent, an enzyme, a bleaching agent, a bleach activator, a chelating agent, an additional chlorine scavenger, a biocide, an optical brightener, a bitterant, a corrosion inhibitor, and a combination thereof.

In some aspects, the detergent composition comprises about 5 to about 20 wt % water, a total of about 35 to about 65 wt % surfactants comprising at least one anionic surfactant and at least one nonionic surfactant, at least one amino acid or a salt thereof, a base, a non-aqueous solvent comprising an alcohol, a polyol, or a combination thereof, and optionally a biocide, an optical brightener, a chelant, a corrosion inhibitor, and/or a bitterant.

In some aspects, the detergent composition comprises about 5 to about 20 wt % water, a total of about 35 to about 65 wt % surfactants comprising at least one anionic surfactant and at least one nonionic surfactant, at least one amino acid or a salt thereof, a base, a non-aqueous solvent comprising an alcohol, a polyol, or a combination thereof, and optionally a biocide, an optical brightener, a chelant, a corrosion inhibitor, and/or a bitterant.

In some aspects, the detergent composition scavenges chlorine to a concentration of 0 ppm in less than about 60 sec after contact with a 1 L water sample comprising up to 4 ppm chlorine. In some aspects, the detergent composition scavenges chlorine to a concentration of 0 ppm in less than about 30 sec after contact with a 1 L water sample comprising up to 4 ppm chlorine.

In some aspects, the water-soluble film material comprises polyvinyl alcohol (PVOH) or polyvinyl acetate (PVA).

### BRIEF DESCRIPTION OF THE DRAWING/FIGURE

FIG. 1 is a titration graph of pH versus amount of 50% NaOH solution (g) for triethanolamine (TEA) (●) and lysine (▴).

### DETAILED DESCRIPTION

Provided herein is a unit dose product comprising a pouch formed from a water-soluble film material; and a detergent composition comprising about 5 to about 20 wt % water, about 35 to about 65 wt % of at least one surfactant, at least one amino acid or a salt thereof, a base, and a non-aqueous solvent, wherein the detergent composition is disposed within the pouch.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number ±10%. For example, “about 10” means 9 to 11.

The phrase “substantially free of” means that a composition contains little no specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

Unless states otherwise, the term “by weight of the composition” refers to a composition of a final product derived from a process, unless otherwise defined.

The terms “process” and “method” can be used interchangeably.

“Alkoxylate” or “alkoxylated” as used in the present application means: the presence of an polyaliphatic ether moiety in a compound, such as ethoxylate (—CH₂CH₂O—) or propoxylate (—CH(CH₃)CH₂O—). A polyethoxylate is multiple repeat units of ethoxylate ((—CH₂CH₂O—)ₙ), and a polypropoxylate is multiple repeat units of propoxylate ((—CH(CH₃) CH₂O—)ₘ). The subscripts “n” and “m” are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

“Amylases” as used in the present application means: class of enzymes that catalyze the hydrolysis of starch into sugars such as glucose and maltose.

“Cellulase” as used in the present application means: class of enzymes that catalyze the cellylolysis or hydrolysis of cellulose.

“Endocellulases” as used in the present application means: class of cellulases that hydrolyze glycoside links within cellulose chains.

“Exocellulases” as used in the present application means: class of cellulases that hydrolyze glycoside links at the ends of cellulose chains.

“Lipases” as used in the present application means: class of enzymes that catalyze the hydrolysis of fats or lipids.

“Mannanases” as used in the present application means: class of enzymes that catalyze the hydrolysis of mannose derivatives.

“Mannose” as used in the present application means: sugar monomer of the aldohexose series of carbohydrates.

“Proteases” as used in the present application means: class of enzymes that catalyze the hydrolysis of proteins.

### Detergent Composition

In some aspects, the present disclosure is directed to a unit dose product comprising a pouch formed from a water-soluble film material; and a detergent composition comprising about 5 to about 20 wt % water, about 35 to about 65 wt % of at least one surfactant, at least one amino acid, a base, and a non-aqueous solvent, wherein the detergent composition is disposed within the pouch.

The present disclosure is predicated on the discovery that an amino acid can be used in a detergent composition enclosed within a unit dose product as a chlorine scavenger and, in some circumstances, a pH buffer. As an added benefit, the use of an amino acid is environmentally friendly.

The detergent composition comprises at least one (e.g., 1, 2, 3, 4, 5, or 6, etc.) amino acid to act as a chlorine scavenger. In some aspects, the at least one amino acid further acts as a pH buffer. In some aspects, the at least one amino acid is a naturally occurring amino acid, including one of the 20 naturally occurring amino acids (e.g., alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, or any combination thereof). In some aspects, the amino acid has a charged side chain (e.g., arginine, aspartic acid, glutamic acid, histidine, or lysine). In some aspects, the at least one amino acid has a polar uncharged side chain (e.g., serine, threonine, asparagine, or glutamine). In the aspects, the at least one amino acid has a hydrophobic side chain (e.g., alanine, valine, isoleucine, leucine, methionine, phenylalanine, tyrosine, or tryptophan). In some aspects, the at least one amino acid is cysteine, glycine, or proline. In some aspects, the at least one amino acid has a charged side chain or a polar uncharged side chain. In some aspects, the at least one amino acid is in the form of a salt, e.g., lysine hydrochloride.

In some aspects, the detergent composition comprises one or two amino acids, but in some aspects, the detergent composition comprises one amino acid. In some aspects, the at least one amino acid is lysine, threonine, any salt thereof, or a combination of lysine and threonine including salts thereof. In some aspects, the detergent composition comprises lysine or a salt thereof (e.g., lysine hydrochloride).

In some aspects, the detergent composition comprises from about 0.001 wt % to about 5 wt % of total amount of at least one amino acid (e.g., lysine, threonine, any salt thereof, or a combination of both) relative to the total weight of the composition. For example, the total amino acid content can be from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition.

In some aspects, the detergent composition comprises from about 5 wt % to about 20 wt % of water relative to the total weight of the composition. For example, the water content can be present in an amount from about 5 wt % to about 18 wt %, about 5 wt % to about 15 wt %, about 5 wt % to about 12 wt %, about 5 wt % to about 10 wt %, about 6 wt % to about 20 wt %, about 6 wt % to about 18 wt %, about 6 wt % to about 15 wt %, about 6 wt % to about 12 wt %, about 6 wt % to about 10 wt %, about 7 wt % to about 20 wt %, about 7 wt % to about 18 wt %, about 7 wt % to about 15 wt %, about 7 wt % to about 12 wt %, about 7 wt % to about 10 wt %, about 8 wt % to about 20 wt %, about 8 wt % to about 18 wt %, about 8 wt % to about 15 wt %, about 8 wt % to about 12 wt %, about 8 wt % to about 10 wt %, about 9 wt % to about 20 wt %, about 9 wt % to about 18 wt %, about 9 wt %, about 15 wt %, about 9 wt %, about 12 wt %, about 20 wt %, about 19 wt %, about 18 wt %, about 17 wt %, about 16 wt %, about 15 wt %, about 14 wt %, about 13 wt %, about 12 wt %, about 11 wt %, about 10 wt %, about 9 wt %, about 8 wt %, about 7 wt %, about 6 wt %, about 5 wt %, about 4 wt %, or about 3 wt % of the total weight of the composition.

The detergent composition comprises at least one non-aqueous solvent in addition to water. In some aspects, the non-aqueous comprises an alcohol, a polyol (e.g., a diol, a triol, or higher, such as polyethylene glycol), or a combination thereof. Suitable examples of a solvent include, e.g., ethylene glycol, diethylene glycol, triethylene glycol, diethylene glycol monobutyl ether, propylene glycol, dipropylene glycol, tripropylene glycol, dipropylene glycol monobutyl ether, 1,3-butylene glycol, 1,4-butylene glycol, 1-(1-butoxy-2-propoxy)-2-propanol, 2-methyl-2,4-pentanediol, 1,5-pentanediol, 1,6-hexanediol, glycerin, polyethylene glycol, ethanol, or a combination thereof.

In some aspects, the at least one non-aqueous solvent comprises polyethylene glycol (PEG), which can have the structure:

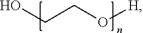

wherein n in each formula is an integer from 1 to 25 (e.g., 1 to 24, 1 to 23, 1 to 22, 1 to 21, 1 to 20, 1 to 18, 1 to 15, 1 to 12, 1 to 10, 2 to 25, 2 to 24 to 2 to 23, 2 to 22, 2 to 21, 2 to 20, 2 to 18, 2 to 15, 2 to 12, 2 to 10, 4 to 25, 4 to 23, 4 to 20, 4 to 18, 4 to 15, 4 to 12, 4 to 10, 7 to 25, 7 to 23, 7 to 20, 7 to 18, 7 to 15, 7 to 12, 7 to 10, 9 to 25, 9 to 23, 9 to 20, 9 to 18, 9 to 15, 9 to 12, etc.). In some aspects, n can be 1, 2, 3, 4, 5, 6, 7, 8, 9, 10, 11, 12, 13, 14, 15, 16, 17, 18, 19, 20, 21, 22, 23, 24, or 25.

In some aspects, the PEG has a molecular weight (including a number average molecular weight) of about 60 to about 1500 g/mol (e.g., about 60 to about 1200 g/mol, about 60 to about 1000 g/mol, about 100 to about 1500 g/mol, about 100 to about 1200 g/mol, about 100 to about 1000 g/nmol, about 200 to about 1500 g/mol, about 200 to about 1200 g/mol, about 200 to about 1000 g/mol, about 300 to about 1500 g/mol, about 300 to about 1200 g/mol, about 300 to about 1000 g/mol, about 400 to about 1500 g/mol, about 400 to about 1200 g/mol, about 400 to about 1000 g/mol, about 200 g/mol, about 400 g/mol, or about 1000 g/mol).

In some aspects, the at least one (e.g., 1, 2, 3, 4, 5, or 6, etc.) surfactant is an anionic surfactant, a cationic surfactant, a zwitterionic surfactant, a nonionic surfactant, or a combination thereof. For example, the detergent composition can comprise a combination of anionic surfactants and nonionic surfactants.

The anionic surfactant can comprise a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃⁻), a phosphate (—OPO₃³⁻), a carboxylate (—C(O)O—), or the conjugate base of an organic acid. In some aspects, polyethylene glycol repeat units designated as “ether” can be disposed between the hydrophobic tail group (e.g., a fatty group) and hydrophobic head group.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.), Group II (e.g., magnesium, calcium, etc.), or ammonium salt.

Examples of an alkyl sulfate include, e.g., a fatty sulfate (e.g., octylsulfate, decyl sulfate, lauryl (dodecyl) sulfate, myristyl sulfate), dioctyl sodium sulfosuccinate, and an alcohol ethoxysulfate with the structure R¹—O—(EO)ₙSO₃Na, in which R¹ is a C₈-C₁₈ alkyl group (linear or branched), EO is polyethylene oxide, n is typically 1 to 8 (e.g., lauryl ether sulfate). Other examples of fatty sulfate include, e.g., 3-sulfopropyl ethoxylate laurylphenyl ether and coco (coconut fatty acid) sulfate. Examples of an alkyl sulfonate include, e.g., a linear alkylbenzene sulfonate (e.g., sodium laurylbenzene sulfonate), a perfluoroalkyl sulfonate (e.g., perfluorooctyl sulfonate, perfluorobutyl sulfonate), and a methyl ester sulfonate. Examples of a fatty acid salt include, e.g., a caprylate, a laurate, a palmitate, a myristate, and a stearate. Other anionic surfactants include a bile acid salt, a glutamic acid salt (e.g., N-myristoly-1-glutamic acid), a glycolic acid salt, a cholic acid salt, a carboxylic poly(ethylene glycol) ether (e.g., glycolic acid ethoxylate laurylphenyl ether, glycolic acid ethoxylate oleyl ether), a taurate (e.g., sodium oleic acid methyl taurate, sodium coconut fatty acid methyl taurate, sodium cocyl methyl taurate), or a combination thereof.

In some aspects, the anionic surfactant comprises an alkyl sulfate (e.g., a lauryl sulfate), a coco fatty acid, a linear alkylbenzene sulfonate, an alcohol ethoxysulfate, a methyl ester sulfonate, or a combination thereof. In some aspects, the anionic surfactant comprises a linear alkylbenzene sulfonate, an alcohol ethoxysulfate, a methyl ester sulfonate, or a combination thereof.

The linear alkylbenzene sulfonate can have the structure of formula (I):

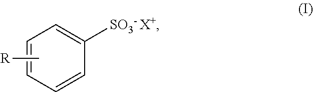

in which R is a linear C₁₀-C₁₈ (e.g., C₁₀, C₁₁, C₁₂, C₁₃, C₁₄, C₁₅, C₁₆, C₁₇, and C₁₈) alkyl, and X⁺ is a cation that balances the charge of the sulfonate. The benzylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another.

In general, the methyl ester sulfonate can have the structure of formula (II):

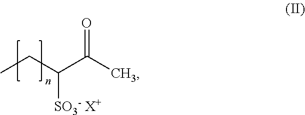

in which n is 10 to 16 (e.g., 10, 11, 12, 13, 14, 15, or 16) to form a C₁₂-C₁₈ alkyl (e.g., C₁₂, C₁₃, C₁₄, C₁₅, C₁₆, C₁₇, and C₁₈) and X⁺ is a cation that balances the charge of the sulfonate.

In some aspects, the cation X⁺ can be of formula (I) and/or (II) is a Group I cation, such as sodium cation or potassium cation, particularly sodium cation. In some aspects, the anionic surfactant comprises a methyl ester sulfonate.

The cationic surfactant comprises a hydrophobic tail group (e.g., a linear aliphatic chain) and a cationic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic hydrophilic group can be, for example, an amino group that can be quaternized, such as trialkylammonium. The counterion can be any suitable anion that can balance the charge. In some aspects, the counterion is an anion with a −1 charge (e.g., X⁻), such as a halide (e.g., chloride, bromide, etc.), hydroxy, or tosylate.

In some aspects, the surfactant can be alkoxylated, in which polyalkylene glycol (e.g., polyethylene glycol, polypropylene glycol) repeat units can be disposed between the hydrophobic tail group (e.g., a fatty group) and hydrophobic head group.

In some aspects, the cationic surfactant can be a fatty amine salt or a quaternary ammonium compound. In some aspects, the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or a combination thereof. Examples of the fatty amine salt include, e.g., a C₈-C₁₈ fatty amine salt (e.g., R¹—NH₃⁺, in which R¹ is a C₈-C₁₈ alkyl group). Examples of a fatty diamine salt include, e.g., R¹—NH₂⁺—R²—NH₃+, in which R¹ is a C₈-C₁₈ alkyl group and R² is a C₁₆ alkyl). Examples of an alkoxylated amine and an alkoxylated diamine include a polyethoxylated fatty amine and diamine, respectively. Examples of a fatty quaternary ammonium compound include, e.g., R¹—NR₃³⁺, in which R¹ is a C₈-C₁₈ alkyl group and each R³ is a C₁-4 alkyl, phenyl, or benzyl (e.g., alkyltrimethylammonium halide, alkyltrimethylammonium tosylate, alkyltrimethylammonium hydroxide). Examples of a fatty amide quaternary ammonium compound include, e.g., R¹—C(O)N—R²—NR₃³⁺, in which R¹ is a C₈-C₁₈ alkyl group, R² is a C₁₆ alkyl, and each R³ is a C₁-4 alkyl, phenyl, or benzyl (e.g., trimethylammonium stearamide). Examples of an alkoxylated quaternary ammonium compound include, e.g., a polyethoxylated quaternary ammonium compound. Examples of a benzalkyl quaternary ammonium compound include, e.g., benzyl-C₈-C₁₈ alkyldimethylammonium (e.g., benzalkonium chloride).

The zwitterionic surfactant is amphoteric and comprises a hydrophobic tail group (e.g., a linear aliphatic chain) and a hydrophilic head group with both a cationic charge and an anionic charge. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic moiety can be, for example, a quaternary ammonium group, such as dialkylammonium or trialkylammonium (e.g., C₁-C₄ alkyl, such as methyl). The anionic moiety can be, for example, oxo (O—), a sulfate (—OSO₃⁻), sulfonate (—SO₃⁻), a phosphate (—OPO₃³⁻), a carboxylate (—C(O)O—), or the conjugate base of an organic acid.

In some aspects, the zwitterionic surfactant comprises a betaine, a sulfonated quaternary ammonium compound, a phosphonated quaternary ammonium compound, a trialkylamine N-oxide, or a combination thereof.

Examples of a betaine include, e.g., C₈-C₁₈ alkyl betaine, cocobetaine, cocamidopropyl betaine, amidosulfobetaine-16, hexadecyl hydroxypropyl sulfobetaine, lauryl-N,N-(dimethylammonio) butyrate, and lauryl-N,N-(dimethyl)-glycinebetaine. Examples of a sulfonated quaternary ammonium compound include, e.g., 3-(N,N-dimethyl-octylammonio) propanesulfonate, 4-(N,N-dimethyl-dodecylammonio) butanesulfonate, 3-{N,N-dimethyl-N-[3-(4-octylbenzoylamino) propyl]ammonio} propanesulfonate, 3-[(3-cholamidopropyl) dimethylammonio]-1-propanesulfonate, 3-([3-cholamidopropyl] dimethylammonio)-2-hydroxy-1-propanesulfonate, coco (amidopropyl) dimethylammonio-2-hydroxypropanesulonate, lauryl-N,N-(dimethylammonio) butyrate, lauryl-N,N-(dimethyl)-propanesulfonate, 3-(4-tert-butyl-1-pyridinio)-1-propanesulfonate, 3-(1-pyridinio)-1-propanesulfonate, and 3-(benzyl-dimethylammonio) propanesulfonate. Examples of a phosphonated quaternary ammonium compound include, e.g., a phosphocholine, such as N-dodecylphosphocholine and hexadecyl phosphocholine. Examples of a trialkylamine N-oxide include, e.g., R¹—N(O—) R²₂⁺, in which R¹ is a C₈-C₁₈ alkyl group, R² is a C₁₄ alkyl, such as lauryldimethylamine N-oxide and 4-ethyl-N,N-2-trimethyloctan-1-amine oxide.

The nonionic surfactant comprises a hydrophobic tail group (e.g., a linear aliphatic chain) and an uncharged (i.e., neutral) hydrophilic head group. The hydrophobic tail group can be a C₈-C₁s aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ₙ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a fatty alcohol alkoxylate, a fatty acid alkoxylate, an alkyl phenol ethoxylate, an alkoxylated amine, an alkyl glucoside, a fatty amide alkoxylate, a diester of alkoxylated fatty acid, an alkoxylated methyl ester of fatty acid (e.g., a methyl ester ethoxylate), a glycerol fatty ester, castor oil alkoxylate, an ethylene oxide-propylene oxide block copolymer, a phenol alkoxylate, or a combination thereof.

Examples of a fatty alcohol alkoxylate include, e.g., C₈-C₁₈ ethoxylate and C₈-C₁₈ propoxylate. Examples of a fatty acid alkoxylate include, e.g., R¹—C(O)O—EO—H, in which R¹ is a C₈-C₁₈ alkyl group and EO is polyethylene oxide. Examples of an alkyl phenol ethoxylate include, e.g., R¹-phenyl-O(EO)—H, in which R¹ is a C₈-C₁₈ alkyl group and EO is polyethylene oxide. Examples of an alkoxylated amine include, e.g., ethoxylated C₈-C₁₈ alkylamine, tallow amine ethoxylate, lauryl amine ethoxylate ether, 2-2-(2-hydroxyethoxy) ethylaminoethanol, bis(hydroxyethoxyethyl) amine, 2,2′-((2-(2-hydroxyethoxy) ethyl) azanediyl) diethanol, and coco bis(2-hydroxyethyl) amine. Example of an alkyl glucoside include, e.g., alkyl polyglucoside, such as C₈-C₁₈ polyglucoside which can include 1 to 3 glucoside units. Examples of a fatty amide alkoxylate include R¹—C(O) NH—(EO)—H, in which R¹ is a C₈-C₁₈ alkyl group and EO is polyethylene oxide. Examples of a diester of alkoxylated fatty acid include, e.g., R¹—C(O)O—EO—C(O)—R^{1′}, in which R¹ and R^{1′} is a C₈-C₁₈ alkyl group and EO is polyethylene oxide. Examples of an alkoxylated methyl ester of fatty acid (e.g., a methyl ester ethoxylate) include e.g., R¹—C(O)O—EO—R², in which R¹ is a C₈-C₁₈ alkyl group, R² is a C₁-C₄ alkyl group, and EO is polyethylene oxide. Examples of a glycerol fatty ester include, e.g., an ester formed from glycerol and a fatty acid (e.g., C₈-C₁₈ alkyl), such as 2-ethylhexyl oleate, glycerol trioleate, glyceryl monooleate, glyceryl monotallate, n-butyl stearate, neopentylglycol dioleate, pentaerythritol monooleate, pentaerythritol tetraoleate, and trimethylolpropane trioleate. An example of a castor oil alkoxylate is polyethoxylated castor oil. Examples of an ethylene oxide-propylene oxide block copolymer include, e.g., R³O—(EO)ₙ—(PO)ₘ—(EO)ₙ—R⁴, in which R³ and R⁴ are the same or different and each is a C₁-C₇ alkyl, a C₅-C₆ cycloalkyl, or an aryl; n is an integer of 30-150 (e.g., about 40-135, about 42-133), and m is an integer of about 10-100 (e.g., about 10-80, about 20-70, about 21-68) and block copolymers such as, PEO-PPO-PEO and PPO-PEO-PPO. Examples of a phenol alkoxylate include, e.g., R⁵-C₆H₄—(EO)—H, wherein R⁵ is hydrogen or a C₁-C₁₈ alkyl group, and EO is polyethylene oxide, such as octyphenol ethoxylate, nonylphenol ethoxylate, 2-phenoxydecan-1-ol, bisphenol ethoxylate, and a styrenated phenol ethoxylate (e.g., tristyrylphenol ethoxylate).

In some aspects, the nonionic surfactant comprises a fatty alcohol ethoxylate as a nonionic surfactant. In general, the fatty alcohol ethoxylate will have a chemical structure of formula (III):

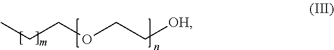

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and C₁₈), and n is an integer of 1 to 15 (e.g., 1, 2, 3, 4, 5, 6, 7, 8, 9, 10, 11, 12, 13, 14, or 15). The fatty alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the fatty alcohol ethoxylate comprises ethoxylated lauryl alcohol.

In some aspects, the detergent composition comprises at least one anionic surfactant and at least one nonionic surfactant. In some aspects, the detergent composition comprises at least one (e.g., 1, 2, 3, 4, 5, or 6, etc.) surfactant selected from an alkyl sulfate (e.g., sodium lauryl sulfate), an alcohol ethoxysulfate, a methyl ester sulfonate, a fatty alcohol ethoxylate (e.g., ethoxylated lauryl alcohol), a linear alkyl benzene sulfonate, an alkoxylated methyl ester of fatty acid (e.g., a methyl ester ethoxylate), and coco fatty acid. In some aspects, the detergent composition comprises a surfactant selected from a fatty alcohol ethoxylate (e.g., ethoxylated lauryl alcohol), a linear alkyl benzene sulfonate, and coco fatty acid.

In some aspects, the detergent composition comprises from about 35 wt % to about 65 wt % of at least one surfactant (e.g., an anionic surfactant, a cationic surfactant, a zwitterionic surfactant, a nonionic surfactant, or a combination thereof) relative to the total weight of the composition. For example, the total surfactant content can be present in an amount from about 35 wt % to about 60 wt %, about 35 wt % to about 55 wt %, about 35 wt % to about 50 wt %, about 38 wt % to about 65 wt %, about 38 wt % to about 60 wt %, about 38 wt % to about 55 wt %, about 38 wt % to about 50 wt %, about 40 wt % to about 65 wt %, about 40 wt % to about 60 wt %, about 40 wt % to about 55 wt %, about 40 wt % to about 50 wt %, about 42 wt % to about 65 wt %, about 42 wt % to about 60 wt %, about 42 wt % to about 55 wt %, about 42 wt % to about 50 wt %, about 45 wt % to about 65 wt %, about 45 wt % to about 60 wt %, about 45 wt % to about 55 wt %, about 45 wt % to about 50 wt %, about 65 wt %, about 64 wt %, about 63 wt %, about 62 wt %, about 61 wt %, about 60 wt %, about 59 wt %, about 58 wt %, about 57 wt %, about 56 wt %, about 55 wt %, about 54 wt %, about 53 wt %, about 52 wt %, about 51 wt %, about 50 wt %, about 49 wt %, about 48 wt %, about 47 wt %, about 46 wt %, about 45 wt %, about 44 wt %, about 43 wt %, about 42 wt %, about 41 wt %, about 40 wt %, about 39 wt %, about 38 wt %, about 37 wt %, about 36 wt %, or about 35 wt % of the total weight of the composition.

In some aspects, the detergent composition can have a pH of about 6.5 to about 12 (e.g., about 7 to about 12, about 7.5 to 12, about 8 to about 12, about 8.5 to 12, about 9 to about 12, about 9.5 to about 12, about 10 to about 12, about 10.5 to about 12, about 11 to about 12, about 11.5 to about 12, about 6.5 to about 11, about 7 to about 11, about 7.5 to about 11, about 8 to about 11, about 8.5 to about 11, about 9 to about 11, about 9.5 to about 11, about 10 to about 11, about 6.5 to about 10, about 7 to about 10, about 7.5 to about 10, about 8 to about 10, about 8.5 to about 10, about 9 to about 10, about 9.5 to about 10, about 6.5 to about 9, about 7 to about 9, about 7.5 to about 9, about 8 to about 9, about 8.5 to about 9). In some aspects, the detergent composition has a pH of greater than 7 (e.g., about 7.1, about 7.2, about 7.3, about 7.4, about 7.5, about 7.6, about 7.7, about 7.8, or about 7.9) or greater. In some aspects, the detergent composition has a pH of about 8 to about 9. In some aspects, the detergent composition has a pH of about 7.1, about 7.2, about 7.3, about 7.4, about 7.5, about 7.6, about 7.7, about 7.8, about 7.9, about 8, about 8.1, about 8.2, about 8.3, about 8.4, about 8.5, about 8.6, about 8.7, about 8.8, about 8.9, about 9, about 9.1, about 9.2, about 9.3, about 9.4, about 9.5, about 9.6, about 9.7, about 9.8, about 9.9, about 10, about 10.1, about 10.2, about 10.3, about 10.4, about 10.5, about 10.6, about 10.7, about 10.8, about 10.9, about 11.1, about 11.2, about 11.3, about 11.4, about 11.5, about 11.6, about 11.7, about 11.8, about 11.9, or about 12.

In some aspects, the detergent composition comprises a base, which is any suitable compound with a pKb of about 1 to about 13. In some aspects, the base can be a Group I hydroxide, a Group II hydroxide, monoethanolamine, diethanolamine, triethanolamine, methyl diethanolamine, sodium tetraborate, trisodium phosphate, sodium carbonate, or a combination thereof. In other aspects, the base is a Group I hydroxide, a Group II hydroxide, sodium tetraborate, trisodium phosphate, sodium carbonate, or a combination thereof. In some aspects, the base can be a monoethanolamine, sodium carbonate, or Group I hydroxide (e.g., sodium hydroxide, potassium hydroxide, or a combination of both).

In some aspects, the detergent composition comprises from about 0.1 wt % to about 15 wt % of base (e.g., a Group I hydroxide) relative to the total weight of the composition. For example, the acid can be present in an amount from about 0.1 wt % to about 12 wt %, about 0.1 wt % to about 10 wt %, about 0.5 wt % to about 15 wt %, about 0.5 wt % to about 12 wt %, about 0.5 wt % to about 10 wt %, about 1 wt % to about 15 wt %, about 1 wt % to about 14 wt %, about 1 wt % to about 13 wt %, about 1 wt % to about 12 wt %, about 1 wt % to about 11 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 15 wt %, about 1.5 wt % to about 10 wt %, about 1.5 wt % to about 8 wt %, about 1.5 wt % to about 5 wt %, about 1.5 wt % to about 3 wt %, about 2 wt % to about 15 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 11 wt %, about 12 wt %, about 13 wt %, about 14 wt %, or about 15 wt % of the total weight of the composition. In some aspects, the detergent composition comprises from about 2 wt % to about 15 wt % or from about 5 to about 10 wt % of base.

In some aspects, the detergent composition is substantially free of a base other than the at least one amino acid (e.g., substantially free of an organic base). At certain pH ranges, the amino acid (e.g., lysine or threonine) can act as a pH buffer. In an example, when the detergent composition comprises lysine or a salt thereof, and the pH of the detergent composition is greater than 7 to about 8.5, an additional base can be added to maintain the pH. However, when the detergent composition comprises lysine or a salt thereof, and the pH of the detergent composition is about 8.5 to about 10, then no other added base may be needed (e.g., the detergent composition is substantially free of a base other than lysine).

In some aspects, the detergent composition comprises a pH buffer (e.g., a basic buffer). The buffer can be any suitable composition that is water soluble and controls (i.e., maintains) the pH of the detergent composition within a pH of greater than 7 to about 10, as described herein. For example, the buffer can comprise a weak base (e.g., ammonia or ammonium hydroxide) and a salt of its conjugate acid (e.g., ammonium chloride, ammonium carbonate, etc.). In some aspects, the buffer comprises monobasic potassium phosphate or dibasic potassium phosphate.

To help maintain the pH, in some aspects, the composition can further comprise an acid, which is any suitable compound with a pKa of less than about 10. In some aspects, the acid is an inorganic acid or an organic acid. Examples of an inorganic acid include hydrochloric acid, nitric acid, nitrous acid, sulfuric acid, sulfurous acid, phosphoric acid, boric acid, hydrobromic acid, hydroiodic acid, perchloric acid, and combinations thereof. In some aspects, the acid is a weak acid such that the acid has a pKa of 2 or greater (e.g., pKa is about 2 to about 10). Examples of a weak acid include, e.g., an organic acid or carbonic acid, hydrocyanic acid, phosphoric acid, sulfurous acid, nitrous acid, or a combination thereof.

In some aspects, the acid in the detergent composition is an organic acid, which in some instances can additionally act as a chelating agent. The organic acid can contain one or more (e.g., 1, 2, or 3) carboxylic acid groups, which can be used singly or in combination. For example, monocarboxylic acids include formic acid, acetic acid, propionic acid, butanoic acid, quinic acid, shikimic acid, lactic acid, sorbic acid, caproic acid, capyrylic acid, capric acid, lauric acid, and stearic acid. Di- and tricarboxylic acids include citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, and oxalic acid. In some aspects, the detergent composition comprises citric acid.

In some aspects, the detergent composition comprises from about 0.1 wt % to about 10 wt % of acid (e.g., an organic acid, such as citric acid) relative to the total weight of the composition. For example, the acid can be present in an amount about 0.5 wt % to about 10 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the composition.

In some aspects, the detergent composition further comprises at least one additive. The additive is any suitable component that does not reduce the at least one amino acid's ability to scavenge chlorine. For example, the at least one (e.g., 1, 2, 3, 4, 5, or 6, etc.) additive can be selected from an anti-redeposition polymer, an enzyme, a bleaching agent, a bleach activator, a chelating agent, an additional chlorine scavenger, a biocide, an optical brightener, a bitterant, a corrosion inhibitor, and a combination thereof.

In some aspects, the detergent composition comprises from about 1 wt % to about 10 wt % of a total amount of additives relative to the total weight of the composition. For example, the total amount of additives can be from about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the composition.

In some aspects, the detergent composition comprises an anti-redeposition agent. In some aspects, the anti-redeposition polymer is biodegradable. The anti-redeposition polymer can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition polymer include, e.g., sodium polyacrylate, modified polyethylene glycol, styrene-acyrlic acid copolymer, polyethylene imine, or a combination thereof. In some aspects, the anti-redeposition polymer comprises sodium polyacrylate.

In some aspects, the detergent composition comprises from about 0.001 wt % to about 5 wt % of an anti-redeposition polymer relative to the total weight of the composition. For example, the anti-redeposition polymer can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises an enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats. A mannanase is capable of breaking down guar and locust bean stains. In some aspects, the at least one enzyme is a hydrolytic enzyme. The at least one enzyme can comprise a protease, an amylase, a mannanase, a lactase, a lipase, a perhydrolase, an oxidoreductase, an endocellulase, an exocellulase, or a combination thereof. In some aspects, the detergent composition comprises a protease, an amylase, a mannanase, or a combination thereof.

In some aspects, the detergent composition comprises a total from about 0.01 wt % to about 5 wt % of at least one enzyme (e.g., a protease, an amylase, a mannanse, or a combination thereof) relative to the total weight of the composition. For example, the total enzyme content can from about 0.01 wt % to about 4 wt %, about 0.01 wt % to about 3 wt %, about 0.01 wt % to about 2 wt %, about 0.01 wt % to about 1 wt %, about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the composition.

In some aspects, the detergent composition comprises a bleaching agent (e.g., chlorine or oxygen-releasing bleaching agents) and optionally a bleach activator. In some aspects, the bleaching agent comprises a hydrogen peroxide source as an oxygen-releasing bleaching agent. In some aspects, the hydrogen peroxide source comprises at least one inorganic perhydrate salt comprising a perborate salt, a percarbonate salt, a perphosphate salt, a persulfate salt, a persilicate salt, or a combination thereof. These salts can be counterbalanced by a Group I cation and/or Group II cation (e.g., sodium cation) to form, for example, an alkali metal percarbonate. In some aspects, the at least one inorganic perhydrate salt comprises sodium percarbonate.

In some aspects, the detergent composition comprises from about 0.001 wt % to about 5 wt % of a bleaching agent relative to the total weight of the composition. For example, the bleaching agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a bleach activator, which is any suitable compound that enables the release of oxygen from the bleaching agent. Examples of the bleach activator include, e.g., tetraacetylethylenediamine (TAED), sodium 3,5,5-tri-methyl hexanoyloxybenzene sulfonate (iso-NOBS), sodium nonanoyloxybenzene sulfonate (NOBS), sodium acetoxybenzene sulfonate (ABS), and pentaacetyl glucose. Bleach activators are described in U.S. Pat. No. 6,551,982, the disclosure of which is incorporated herein by reference in its entirety. In some aspects, the detergent composition comprises a bleaching agent (e.g., sodium percarbonate) and a bleach activator (e.g., tetraacetylethylenediamine (TAED)).

In some aspects, the detergent composition comprises from about 0.001 wt % to about 5 wt % of a bleach activator relative to the total weight of the composition. For example, the bleach activator can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, when a bleaching agent is present, a bleach catalyst can be further present in the detergent composition. The bleach catalyst can be a transition metal-containing catalyst, such as a Mn, Fe, Co, Ru, or Mo salen complexes or carbonyl complexes or Mn-, Fe-, Co-, Ru-, Mo-, Ti-, V-, and Cu-complexes with N-containing tripod ligands or Co-, Fe- Cu-, and Ru-ammine complexes.

Complexes of manganese in oxidation stage II, III, IV, or IV are particularly used and which contain one or more macrocyclic ligands with the donor functions N, NR, PR, O, and/or S. For example, a manganese-containing catalyst includes Mn(1,4,7-trimethyl-1,4,7-triazacyclononane) (OCH₃)₃—(PF₆), Mn(IV)₂ (u-O)₃ (1,4,7-trimethyl-1,4,7-triazacyclononane)₂-(PF₆)₂, Mn(III)₂ (u-O): (u-OAc)₂ (1,4,7-trimethyl-1,4,7-triazacyclononane)₂-(ClO₄)₂, Mn (IV)₄(u-O)₆(1,4,7-triazacyclononane)₄-(ClO₄)₂, Mn (III) Mn (IV)₄(u-O): (u-OAc)₂-(1,4,7-trimethyl-1,4,7-triazacyclononane)₂-(ClO₄)₃, and mixtures thereof. Other suitable ligands include 1,5,9-trimethyl-1,5,9-triazacyclododecane, 2-methyl-1,4,7-triazacyclononane, 2-methyl-1,4,7-triazacyclononane, 1,2,4,7-tetramethyl-1,4,7-triazacyclononane, and mixtures thereof. Cobalt-containing catalysts include, for example, cobalt pentaamine chloride salts, such as [Co (NH₃)₅Cl]Cl₂.

In some aspects, the detergent composition comprises from about 0.001 wt % to about 5 wt % of a bleach catalyst relative to the total weight of the composition. For example, the bleach catalyst can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a chelating agent (i.e., a chelant) that serves to improve the cleaning action of the detergent by scavenging metal ions naturally found in water. Suitable examples of a chelating agent includes, e.g., citric acid, nitriloacetic acid, sodium tripolyphosphate, ethylenediaminetetraacetic acid, diethylenetriaminepentaacetic acid, tetrasodium glutamate diacetate, tetrasodium aspartate diacetate, tetrasodium iminodisuccinate, and combinations thereof. In some aspects, the detergent composition comprises tetrasodium iminodisuccinate.

In some aspects, the detergent composition comprises from about 0.001 wt % to about 5 wt % of a chelating agent relative to the total weight of the composition. For example, the chelating agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a chlorine scavenger in addition to the at least one amino acid or a salt thereof. The chlorine scavenger is any compound that can react with chlorine or a chlorine-generating compound (e.g., hypochlorite) to eliminate or reduce the bleaching activity. In some aspects, the chlorine scavenger can also act as a corrosion inhibitor. Examples of a chlorine scavenger include, e.g., potassium nitrate, sodium nitrate, tetrasodium iminodisuccinate, tris (hydroxymethyl) aminomethane, 2-amino-2-methyl-1, 3-propanediol, 2-amino-2-ethyl-1, 3-propanediol, 2-amino-1-butanol, 1-amino-2-propanol, 2-amino-1-propanol, 2-amino-2-methyl-1-propanol, and combinations thereof. In some aspects, the chlorine scavenger can be tetrasodium iminodisuccinate.

In some aspects, the detergent composition does not comprise (e.g., is substantially free of) a chlorine scavenger other than the at least one amino acid. In other aspects, the detergent composition comprises from about 0.001 wt % to about 5 wt % of an additional chlorine scavenger relative to the total weight of the composition. For example, the additional chlorine scavenger can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a biocide, which is any suitable compound with antimicrobial (e.g., antibacterial, antiviral, antifungal) activity. Examples of a biocide include, e.g., dichloroisocyanuric acid, hydrogen peroxide, a quaternary ammonium compound, glutaraldehyde, tetrakis (hydroxymethyl) phosphonium sulfate (THPS), 2,2-dibromo-3-nitrilopropionamide (DBNPA), 2,2-dibromo-3-nitrilpropionamide, 2-(hydroxymethylamino)-ethanol, 2-bromo-2-nitropropane-1,3-diol, β-bromo-β-nitrostyrene, 1,2-dibromo-2,4-dicyanobutane (DBDCB), 2,2-dibromo-3-nitrilopropionamide (DBNPA), 3-iodo-2-propynylbutyl carbamate (IPBC), chlorthalonil, 1-bromo-3-chloro-5,5-dimethylhydantoin, 5-chloro-2-methyl-4-isothiazolin-3-one, 2-methyl-4-isothiazolin-3-one, 1,2-benzisothiazolin-3-one, and combinations thereof. In some aspects, the biocide can be 5-chloro-2-methyl-4-isothiazolin-3-one, 2-methyl-4-isothiazolin-3-one, 1,2-benzisothiazolin-3-one, or a combination thereof.

In some aspects, the detergent composition comprises from about 0.001 wt % to about 5 wt % of a biocide relative to the total weight of the composition. For example, the biocide can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises an optical brightener (e.g., a fluorescent whitening agent), which is any suitable hydrophilic compound that absorbs ultra violet light and emits visible (e.g., blue-violet) light to make textiles appear brighter. The optical brightener can comprise a triazole, a stilbene, or a biphenyl group. Examples of the optical brightener include, e.g., 2,2′-(2,5-thienediyl) bis [5-(2-methyl-2-propanyl)-1,3-benzoxazole, 5,5′-((perfluorocyclopent-1-ene-1,2-diyl) bis(5-methylthiophene-4,2-diyl)) bis(2-(6-methoxybenzo[d] thiazol-2-yl)-1,3,4-oxadiazole), 5,5′-((perfluorocyclopent-1-ene-1,2-diyl) bis(5-methylthiophenc-4,2-diyl)) bis(2-(6-methoxybenzo[d] thiazol-2-yl)-1,3,4-oxadiazole), 2′,7′-bis(5-(4-(tert-butyl) phenyl)-1,3,4-oxadiazol-2-yl)-N³,N³,N⁶,N⁶-tetraphenyl-9,9′-spirobi [fluorene]-3,6-diamine, N,N-diphenyl-4-(5-(4-(triphenylsilyl) phenyl)-1,3,4-oxadiazol-2-yl) aniline, ((4-((4-(5-(4-nitrophenyl)-1,3,4-oxadiazol-2-yl) phenyl) diazenyl) phenyl) azanediyl) bis(ethane-2,1-diyl) diacetate, ((4-((4-(5-(4-((E)-4-nitrostyryl) phenyl)-1,3,4-oxadiazol-2-yl) phenyl) diazenyl) phenyl) azanediyl) bis(ethane-2,1-diyl) diacetate, 4,4′-diamino-2,2′-stilbenedisulfonic acid, 4,4′-bis(benzoxazolyl)-cis-stilbene, and 2,5-bis(benzoxazol-2-yl) thiophene, and combinations thereof. In some aspects, the optical brightener can be 2,2′-(2,5-thienediyl) bis [5-(2-methyl-2-propanyl)-1,3-benzoxazole.

In some aspects, the detergent composition can comprise from about 0.001 wt % to about 5 wt % of an optical brightener relative to the total weight of the composition. For example, the optical brightener can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition can comprise a bitterant (e.g., a bittering agent), which is any suitable compound that imparts a bitter taste to the composition. The bitterant can be added to avoid accidental poisoning. Examples of the bitterant include, e.g., denatonium benzoate, sucrose octaacetate, quercetin, brucine, quassin, and combinations thereof. In an aspect, the bitterant can be denatonium benzoate.

In some aspects, the detergent composition can comprise from about 0.001 wt % to about 1 wt % of a bitterant relative to the total weight of the composition. For example, the optical brightener can be present in an amount from about 0.001 wt % to about 0.9 wt %, about 0.001 wt % to about 0.8 wt %, about 0.001 wt % to about 0.7 wt %, about 0.001 wt % to about 0.5 wt %, about 0.005 wt % to about 1 wt %, about 0.005 wt % to about 0.9 wt %, about 0.005 wt % to about 0.8 wt %, about 0.005 wt % to about 0.6 wt %, about 0.005 wt % to about 0.5 wt %, about 0.01 wt % to about 1 wt %, about 0.01 wt % to about 0.9 wt %, about 0.01 wt % to about 0.8 wt %, about 0.01 wt % to about 0.7 wt %, about 0.05 wt % to about 0.6 wt %, about 0.05 wt % to about 0.5 wt %, about 0.05 wt % to about 0.2 wt %, about 0.05 wt % to about 0.1 wt %, about 0.1 wt % to about 1 wt %, about 0.1 wt % to about 0.9 wt %, about 0.1 wt % to about 0.8 wt %, about 0.1 wt % to about 0.5 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt % of the total weight of the composition.

In some aspects, the detergent composition comprises a corrosion inhibitor (e.g., an oxygen scavenger), which is any suitable compound that lowers the dissolved oxygen content in the washing medium by reacting with oxygen. The corrosion inhibitor can, for example, protect the inside of a washing machine from rusting. Examples of the corrosion inhibitor include, e.g., an inorganic corrosion inhibitor (e.g., a sulfite, a silicate, a polyphosphate, calcium hydroxide), an organic corrosion inhibitor (e.g., calcium hydrogen carbonate, a sulfonate, a phosphonate, a C₁₂-C₁₅ alcohol ether phosphate), or a combination thereof. In an aspect, the corrosion inhibitor can be sodium sulfite.

In some aspects, the detergent composition comprises from about 0.001 wt % to about 5 wt % of a corrosion inhibitor (e.g., an oxygen scavenger) relative to the total weight of the composition. For example, the corrosion inhibitorcan be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises an optical brightener, a chelating agent, a corrosion inhibitor, a bitterant, or any combination thereof as additives. In some aspects, the detergent composition comprises a combination of an optical brightener, a chelating agent (e.g., tetrasodium iminodisuccinate), a corrosion inhibitor (e.g., sodium sulfite), and a bitterant (e.g., denatonium benzoate) as additives.

In an aspect, the unit dose product comprises a detergent composition comprising 5 to about 20 wt % water, about 35 to about 65 wt % of at least one surfactant, at least one amino acid or a salt thereof, a base, and a non-aqueous solvent. For example, the detergent composition comprises:
about 5 to about 20 wt % water;
about 35 to about 65 wt % of at least one surfactant;
about 0.001 wt % to about 5 wt % of at least one amino acid or a salt thereof; and
about 0.1 wt % to about 15 wt % of a base, and
a non-aqueous solvent.

The amounts of each component will be selected to provide a detergent composition comprising 100 wt % of the total composition.

In an aspect, the unit dose product consisting essentially of a detergent composition comprising 5 to about 20 wt % water, about 35 to about 65 wt % of at least one surfactant, at least one amino acid or a salt thereof, a base, and a non-aqueous solvent. For example, the detergent composition consists essentially of:
about 5 to about 20 wt % water;
about 35 to about 65 wt % of at least one surfactant;
about 0.001 wt % to about 5 wt % of at least one amino acid or a salt thereof; and
about 0.1 wt % to about 15 wt % of a base, and a non-aqueous solvent.

The amounts of each component will be selected to provide a detergent composition comprising 100 wt % of the total composition.

In an aspect, the unit dose product comprises a detergent composition consisting of 5 to about 20 wt % water, about 35 to about 65 wt % of at least one surfactant, at least one amino acid or a salt thereof, a base, and a non-aqueous solvent. For example, the detergent composition consists of:
about 5 to about 20 wt % water;
about 35 to about 65 wt % of at least one surfactant;
about 0.001 wt % to about 5 wt % of at least one amino acid or a salt thereof; and
about 0.1 wt % to about 15 wt % of a base, and
a non-aqueous solvent.

The amounts of each component will be selected to provide a detergent composition comprising 100 wt % of the total composition.

In an example, the detergent composition comprises:
about 5 to about 20 wt % water;
about 35 to about 65 wt % of surfactants comprising at least one anionic surfactant and
at least one nonionic surfactant;
about 0.001 wt % to about 5 wt % of at least one amino acid or a salt thereof; and
about 5 wt % to about 10 wt % of a base, and
a non-aqueous solvent comprising an alcohol, a polyol, or a combination thereof.

The amounts of each component will be selected to provide a detergent composition comprising 100 wt % of the total composition.

In an example, the detergent composition consists essentially of:
about 5 to about 20 wt % water;
about 35 to about 65 wt % of surfactants comprising at least one anionic surfactant and at least one nonionic surfactant;
about 0.001 wt % to about 5 wt % of at least one amino acid or a salt thereof; and
about 5 wt % to about 10 wt % of a base, and
a non-aqueous solvent comprising an alcohol, a polyol, or a combination thereof.

The amounts of each component will be selected to provide a detergent composition comprising 100 wt % of the total composition.

In an example, the detergent composition consists of:
about 5 to about 20 wt % water;
about 35 to about 65 wt % of surfactants comprising at least one anionic surfactant and at least one nonionic surfactant;
about 0.001 wt % to about 5 wt % of at least one amino acid or a salt thereof; and
about 5 wt % to about 10 wt % of a base, and
a non-aqueous solvent comprising an alcohol, a polyol, or a combination thereof.

The amounts of each component will be selected to provide a detergent composition comprising 100 wt % of the total composition.

In an aspect, the detergent composition comprises:
about 5 to about 10 wt % water;
a total of about 40 to about 55 wt % (e.g., about 40 to about 50 wt %) of surfactants selected from sodium lauryl sulfate, a linear alkyl benzene sulfonate, an alcohol ethoxysulfate, a methyl ester sulfonate, a fatty alcohol ethoxylate (e.g., a C₁₂-C₁₅ fatty alcohol ethoxylate with 7 moles of ethoxylate), an alkoxylated methyl ester of fatty acid, and coco fatty acid;
lysine or a salt thereof;
a base (e.g., Group I hydroxide or monoethanolamine);
a non-aqueous solvent comprising glycerin, propylene glycol, polyethylene glycol, and ethanol; and
optionally one or more additives selected from a biocide, an optical brightener, a chelant, a corrosion inhibitor, and a bitterant.

The amounts of each component will be selected to provide a detergent composition comprising 100 wt % of the total composition. In some aspects of this detergent composition, the detergent composition can further comprise an optical brightener, a chelant, a corrosion inhibitor, and a bitterant. In some aspects of this detergent composition, the composition comprises a fatty alcohol ethoxylate, such as a C₁₂-C₁₈ fatty alcohol ethoxylate with 7 moles of ethoxylate.

In an aspect, the detergent composition consists essentially of:
about 5 to about 10 wt % water;
a total of about 40 to about 55 wt % (e.g., about 40 to about 50 wt %) of surfactants selected from sodium lauryl sulfate, a linear alkyl benzene sulfonate, an alcohol ethoxysulfate, a methyl ester sulfonate, a fatty alcohol ethoxylate (e.g., a C₁₂-C₁₅ fatty alcohol ethoxylate with 7 moles of ethoxylate), an alkoxylated methyl ester of fatty acid, and coco fatty acid;
lysine or a salt thereof;
a base (e.g., Group I hydroxide or monoethanolamine);
a non-aqueous solvent comprising glycerin, propylene glycol, polyethylene glycol, and ethanol; and
optionally one or more additives selected from a biocide, an optical brightener, a chelant, a corrosion inhibitor, and a bitterant.

The amounts of each component will be selected to provide a detergent composition comprising 100 wt % of the total composition. In some aspects of this detergent composition, the detergent composition can further consist essentially of an optical brightener, a chelant, a corrosion inhibitor, and a bitterant. In some aspects of this detergent composition, the composition comprises a fatty alcohol ethoxylate, such as a C₁₂-C₁₅ fatty alcohol ethoxylate with 7 moles of ethoxylate.

In an aspect, the detergent composition consists of:
about 5 to about 10 wt % water;
a total of about 40 to about 55 wt % (e.g., about 40 to about 50 wt %) of surfactants selected from sodium lauryl sulfate, a linear alkyl benzene sulfonate, an alcohol ethoxysulfate, a methyl ester sulfonate, a fatty alcohol ethoxylate (e.g., a C₁₂-C₁₅ fatty alcohol ethoxylate with 7 moles of ethoxylate), an alkoxylated methyl ester of fatty acid, and coco fatty acid;
lysine or a salt thereof;
a base (e.g., Group I hydroxide or monoethanolamine);
a non-aqueous solvent comprising glycerin, propylene glycol, polyethylene glycol, and ethanol; and
optionally one or more additives selected from a biocide, an optical brightener, a chelant, a corrosion inhibitor, and a bitterant.

The amounts of each component will be selected to provide a detergent composition comprising 100 wt % of the total composition. In some aspects of this detergent composition, the detergent composition can further consist of an optical brightener, a chelant, a corrosion inhibitor, and a bitterant. In some aspects of this detergent composition, the composition comprises a fatty alcohol ethoxylate, such as a C₁₂-C₁₅ fatty alcohol ethoxylate with 7 moles of ethoxylate.

The detergent composition is enclosed (e.g., entrapped) within a water-soluble film pouch to form of a unit dose product (e.g., a detergent pack). As used herein, the term “water-soluble” means that least 2 grams of the solute (e.g., the film) dissolves in 5 liters of solvent (e.g., water) for a solubility of at least 0.4 grams per liter (g/l) at a temperature of 25° C. unless otherwise specified. Upon contact with water (e.g., water in the wash cycle in a method of washing), the water-soluble film will release the detergent composition.

The pouch can be a single compartment, and the detergent composition is releasably disposed within the single compartment. Alternatively, the pouch can have two or more (e.g., 2, 3, or 4) compartments that are sealed off from one another, and the detergent composition is releasably disposed within at least one of the two or more compartments. In some aspects, the same detergent composition is present in each compartment of the pouch. In some aspects, the other compartment(s) can include colorants or other components, such as an alternative composition in the form of solid or or liquid. In some aspects, the solid composition is a powder, granule, tablet, or combinations thereof. In some aspects, the alternative composition comprises a rinse aid or a fabric softener. In some aspects, different film compositions can be used to form different sections or compartments of the pouch. For example, different films can dissolve at different rates to provide timed release of the compartments' contents.

The sealing of a water-soluble film material (e.g., in the form of one or two sheets) to form a compartment can be performed using methods known to those of skill in the art. In some aspects, the water-soluble film material is sealed using heat-sealing, solvent scaling, or ultraviolet (UV) sealing. In some aspects, the water-soluble film material sealed using water scaling.

The unit dose product (e.g., pouch or detergent pack) can be in any suitable shape and size, e.g., square, rectangular, oval, elliptoid, superelliptical, or circular shape. In general, the size and shape of the pouch is large enough to enclose (e.g., entrap) about 15 g to about 30 g total weight of the detergent composition.

The water-soluble film is desirably strong, flexible, shock resistant, and non-tacky during storage at both high and low temperatures and high and low humidities. Non-limiting examples of suitable materials for the water-soluble film include, e.g., polyvinyl alcohol (PVOH), polyvinyl acetate (PVA), film-forming cellulosic polymers, polyacrylic acid, polyacrylamide, polyanhydride, a polysaccharide, and combinations thereof. Examples of film-forming cellulosic polymer include, e.g., cellulose, cellulose ether, cellulose ester, cellulose amide, methylcellulose, carboxymethylcellulose sodium, ethylcellulose, hydroxyethyl cellulose, hydroxypropyl methyl cellulose (HPMC), and combinations thereof. Unit dose detergent packs, including water-soluble films, are described in U.S. Pat. Nos. 8,551,929, 10,774,294, and 11,492,574, the disclosures of which are incorporated herein by reference in their entirety. In some aspects, the water-soluble film material comprises polyvinyl alcohol (PVOH) or polyvinyl acetate (PVA).

In an aspect, the water-soluble film material is polyvinyl alcohol (PVOH). In some aspects, the PVOH can have a number average molecular weight range of about 10,000 to about 100,000 g/mol (e.g., about 10,000 to about 80,000 g/mol, about 15,000 to about 60,000 g/mol, about 20,000 to about 50,000 g/mol, about 25,000 to about 40,000 g/mol, or about 27,000 to about 33,000).

In some aspects, the film material comprises a bitterant (e.g., denatonium benzoate) as described herein, to impart a bitter taste to help avoid accidental poisoning.

In some aspects, the film material can have a thickness of about 10 to about 100 μm (e.g., about 10 to 90 μm, about 20 to about 80 μm, about 50 to about 100 μm, about 50 to about 80 μm, about 70 to about 80 μm, about 100 μm, about 95 μm, about 90 μm, about 85 μm, about 80 μm, about 75 μm, about 70 μm, about 65 μm, about 60 μm, about 55 μm, about 50 μm, about 45 μm, about 40 μm, about 35 μm, about 30 μm, about 25 μm, about 20 μm, about 15 μm, or about 10 μm). In some aspects, the film material will have a thickness of about 75 μm.

It was unexpectedly discovered that the amino acid in the detergent composition can act as a chlorine scavenger. Water from a municipal source can contain up to 4 ppm chlorine. In some aspects, the detergent composition can scavenge (e.g., reduce) chlorine to a concentration of 0 ppm in less than about 60 sec (e.g., less than about 55 sec, less than about 50 sec, less than about 45 sec, less than about 40 sec, less than about 35 sec, less than about 30 sec, less than about 25 sec, or less than about 20 sec) after initial contact (time=0 sec) with a 1 L sample of water that comprises up to 4 ppm (e.g., up to 3.5 ppm, up to 3 ppm, up to 2.5 ppm, up to 2 ppm, up to 1.5 ppm, or up to 1 ppm) chlorine. In some instances of this method, the water sample will be agitated after the addition of the detergent composition. In some aspects, the detergent composition can scavenge (e.g., reduce) chlorine to a concentration of 0 ppm in less than about 30 sec after contact with a 1 L water sample comprising up to 4 ppm chlorine.

In some aspects, the present disclosure is directed to a method of using the unit dose product of any of the foregoing aspects. For example, the unit dose product can be used in a method of removing soil from a textile (e.g., cleaning a textile, such as a fabric). In particular, the present disclosure is directed to a method of removing soil from a textile comprising contacting the textile with a composition comprising the unit dose product described herein and water to form a washing load. Optional steps include mixing (agitating) the washing load and composition, removing the composition to provide a clean textile, rinsing the clean textile with additional water, and isolating the clean textile. In some aspects, soils that are suitably removed using the unit dose product include, but are not limited to, oil-containing soils, carbohydrate-containing soils, protein-containing soils, tannin-containing soils, particulate soils, and combinations thereof.

In an aspect, the method is directed to protecting a color of a textile (e.g., fabric) comprising adding the unit dose product described herein to water to form a composition and reduce the chlorine level of the water; and contacting the textile with the composition to form a washing load. Optional steps include mixing (agitating) the washing load and composition, removing the composition to provide a clean textile, rinsing the clean textile with additional water, and isolating the clean textile.

The color level of a textile can be measured using any suitable technique, such as spectrophotometry. The color of a textile is protected when the color level of a textile from a starting point (e.g., day 0) and the color level of the same textile after 3 to 30 (e.g., 3 to 25, 3 to 20, 3 to 15, 3 to 10, or 3 to 5) washes (each wash corresponding to a day) with the detergent composition described herein differs by less than about 15% (e.g., less than about 10%, less than about 8%, less than about 5%, less than about 3%, less than about 2%, less than about 1%).

In some aspects of these methods, the method can be performed using a washing machine, a tergetometer, or an equivalent device. In some aspects of these methods, the textile is a fabric comprising a red, blue, or black dye. In some aspects of these methods, the water is hot or warm water. In some aspects of these methods, the water is cold water. In some aspects of these methods, the water is municipal water.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

An initial formulation was prepared with the components listed in Table 1.

TABLE 1

| | Activity | Use |
|---|---|---|
| COMPONENT | % | Level % |
| Non-Aqueous Solvents | 100 | 28.9 |
| (Polyethylene Glycol 400, Propylene Glycol, | | |
| Glycerin, Ethanol blend) | | |
| Fatty alcohol ethoxylate (25-7) | 100 | 23.08 |
| Monoethanolamine | 99+ | 6.04 |
| Water | 100 | 6.5 |
| Linear alkylbenzene sulfonic acid | 99 | 17 |
| Coconut Fatty Acid | 100 | 10 |
| Alcohol ethoxy sulfate, 3EO | 70 | 4.8 |
| Sodium Iminodisuccinate (Chelant) | 33 | 0.6 |
| Sodium Sulfite, Optical Brightener, Bittering Agent | N/A | 1.58 |
| Initial Total | | 98.5 |
| Room for Additional Additive | | 1.5 |
| Final Total | | 100.0 |

Formula 1 contained 98.5 parts of the initial formula +1.5 parts glycerin. Formula 2 contained 98.5 parts of the initial formula +1.5 parts of a 33% solution of lysine HCl in deionized (DI) water. Formula 3 contained 98.5 parts of the initial formula +1.5 parts of a 33% solution of threonine in DI water.

The target dose of detergent per wash was approximately 22 grams, and the estimated amount of water in a High Efficiency Washing Machine was 31.4 L. Proportionally, 0.7 grams of detergent was added into 1 L of water for benchtop scale.

With a starting chlorine concentration of 3 ppm in the water, the results in Table 2 were observed after adding 0.7 grams of Formula 1, 2, or 3 to 1 L of the chlorinated water.

TABLE 2

| | | Initial | | | |
|---|---|---|---|---|---|
| | | Chlorine | | | |
| | | Concen- | Chlorine Concentration after | | |
| | | tration | Contact with Formula (ppm) | | |
| Formula | | (ppm) | 15 sec | 30 sec | 60 sec |
| 1 | Control | 3 | 0.5 | 0.25 | 0.25 |
| 2 | 0.5% Lysine HCl | 3 | 0.25 | 0 | 0 |
| 3 | 0.5% Threonine | 3 | 0.5 | 0.25 | 0 |

As seen in Table 2, monoethanolamine (MEA) alone acts as a chlorine scavenger (Formula 1), but the chlorine scavenging ability is markedly increased with the addition of an amino acid or salt thereof (Formulas 2 and 3).

### Example 2

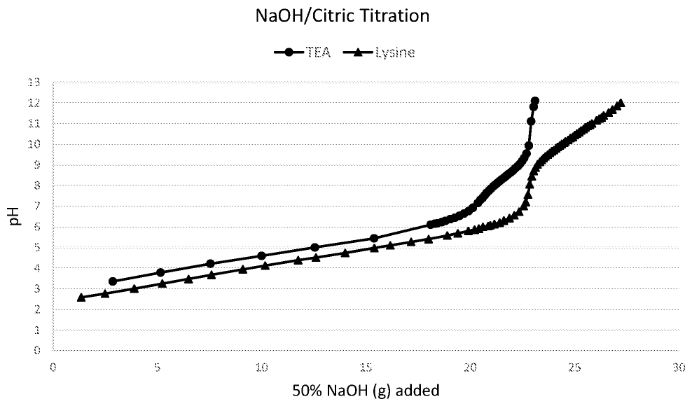

Two solutions of 350 grams of deionized water, 35 grams of 50% citric acid in water, and then 5 grams of either 85% triethanolamine (TEA) or 5.15% of lysine HCl (99% active) were prepared for a titration with 50% NaOH in water. This system simulates the main acidic and basic components of a laundry detergent to measure what pH lysine can buffer effectively compared to the historical use of triethanolamine. The following results were observed, as set forth in Table 3 and FIG. 1.

TABLE 3

| 50% NaOH Added | TEA | 50% NaOH Added | Lysine |
|---|---|---|---|
| (grams) | pH | (grams) | pH |
| 2.87 | 3.35 | 1.36 | 2.58 |
| 5.16 | 3.78 | 2.5 | 2.76 |
| 7.55 | 4.21 | 3.9 | 3 |
| 10 | 4.59 | 5.24 | 3.25 |
| 12.55 | 5 | 6.5 | 3.47 |
| 15.39 | 5.44 | 7.6 | 3.67 |
| 18.1 | 6.1 | 9.1 | 3.94 |
| 18.3 | 6.15 | 10.17 | 4.12 |
| 18.42 | 6.17 | 11.75 | 4.38 |
| 18.64 | 6.23 | 12.6 | 4.51 |
| 18.81 | 6.29 | 14 | 4.73 |
| 19.04 | 6.37 | 15.4 | 4.97 |
| 19.27 | 6.44 | 16.16 | 5.1 |
| 19.48 | 6.53 | 17.16 | 5.27 |
| 19.7 | 6.64 | 18 | 5.4 |
| 19.92 | 6.76 | 18.89 | 5.58 |
| 20.12 | 6.92 | 19.4 | 5.68 |
| 20.36 | 7.15 | 19.9 | 5.8 |
| 20.48 | 7.3 | 20.2 | 5.86 |
| 20.59 | 7.4 | 20.4 | 5.91 |
| 20.69 | 7.53 | 20.6 | 6 |
| 20.78 | 7.64 | 20.85 | 6.04 |
| 20.9 | 7.76 | 20.95 | 6.07 |
| 20.99 | 7.85 | 21.15 | 6.13 |
| 21.1 | 7.96 | 21.4 | 6.2 |
| 21.2 | 8.04 | 21.6 | 6.3 |
| 21.3 | 8.12 | 21.87 | 6.42 |
| 21.4 | 8.21 | 22.1 | 6.56 |
| 21.5 | 8.29 | 22.33 | 6.73 |
| 21.62 | 8.38 | 22.55 | 7 |
| 21.72 | 8.46 | 22.65 | 7.2 |
| 21.81 | 8.54 | 22.76 | 7.56 |
| 21.93 | 8.63 | 22.84 | 8.06 |
| 22.04 | 8.72 | 22.94 | 8.45 |
| 22.15 | 8.83 | 23.03 | 8.7 |
| 22.27 | 8.93 | 23.12 | 8.87 |
| 22.37 | 9.04 | 23.21 | 9.03 |
| 22.48 | 9.18 | 23.33 | 9.15 |
| 22.58 | 9.33 | 23.41 | 9.24 |
| 22.69 | 9.55 | 23.5 | 9.33 |
| 22.8 | 9.93 | 23.59 | 9.41 |
| 22.91 | 11.11 | 23.7 | 9.5 |
| 23.03 | 11.81 | 23.8 | 9.58 |
| 23.1 | 12.1 | 23.9 | 9.66 |
| | | 24 | 9.72 |
| | | 24.1 | 9.81 |
| | | 24.18 | 9.87 |
| | | 24.28 | 9.94 |
| | | 24.37 | 10.01 |
| | | 24.49 | 10.08 |
| | | 24.55 | 10.14 |
| | | 24.68 | 10.21 |
| | | 24.78 | 10.3 |
| | | 24.9 | 10.35 |
| | | 25 | 10.45 |
| | | 25.1 | 10.52 |
| | | 25.21 | 10.59 |
| | | 25.3 | 10.67 |
| | | 25.42 | 10.74 |
| | | 25.51 | 10.82 |
| | | 25.62 | 10.89 |
| | | 25.72 | 10.94 |
| | | 25.82 | 11.01 |
| | | 26.04 | 11.16 |
| | | 26.17 | 11.24 |
| | | 26.28 | 11.3 |
| | | 26.38 | 11.4 |
| | | 26.62 | 11.54 |
| | | 26.8 | 11.68 |
| | | 27.02 | 11.86 |
| | | 27.2 | 12.01 |

As seen in FIG. 1, TEA was shown to buffer well at a pH of about 7 to about 9, whereas lysine acted as a buffer at pH of about 9 to about 12.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A unit dose product comprising
a pouch formed from a water-soluble film material; and
a detergent composition comprising about 5 to about 20 wt % water, about 35 to about 65 wt % of at least one surfactant, at least one amino acid or a salt thereof, a base, and a non-aqueous solvent,
wherein the detergent composition is disposed within the pouch.

2. The unit dose product of claim 1, wherein the at least one amino acid is selected from alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, and a combination thereof.

3. The unit dose product of claim 2, wherein the at least one amino acid has a charged side chain or a polar uncharged side chain.

4. The unit dose product of claim 3, wherein the at least one amino acid is lysine, threonine, any salt thereof, or a combination of lysine and threonine including salts thereof.

5. The unit dose product of claim 1, wherein the at least one surfactant is an anionic surfactant, a cationic surfactant, a zwitterionic surfactant, a nonionic surfactant, or a combination thereof.

6. The unit dose product of claim 5, wherein the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof.

7. The unit dose product of claim 5, wherein the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or a combination thereof.

8. The unit dose product of claim 5, wherein the zwitterionic surfactant comprises a betaine, a sulfonated quaternary ammonium compound, a phosphonated quaternary ammonium compound, a trialkylamine N-oxide, or a combination thereof.

9. The unit dose product of claim 5, wherein the nonionic surfactant comprises a fatty alcohol alkoxylate, a fatty acid alkoxylate, an alkyl phenol ethoxylate, an alkoxylated amine, an alkyl glucoside, a fatty amide alkoxylate, a diester of alkoxylated fatty acid, an alkoxylated methyl ester of fatty acid, a glycerol fatty ester, castor oil alkoxylate, an ethylene oxide-propylene oxide block copolymer, a phenol alkoxylate, or a combination thereof.

10. The unit dose product of claim 1, wherein the detergent composition has a pH of about 6.5 to about 12.

11. The unit dose product of claim 1, wherein the detergent composition has a pH of greater than 7.

12. The unit dose product of claim 1, wherein the base is a Group I hydroxide, a Group II hydroxide, sodium tetraborate, trisodium phosphate, sodium carbonate, or a combination thereof.

13. The unit dose product of claim 1, wherein the non-aqueous solvent is ethylene glycol, diethylene glycol, triethylene glycol, diethylene glycol monobutyl ether, propylene glycol, dipropylene glycol, tripropylene glycol, dipropylene glycol monobutyl ether, 1,3-butylene glycol, 1,4-butylene glycol, 1-(1-butoxy-2-propoxy)-2-propanol, 2-methyl-2,4-pentanediol, 1,5-pentanediol, 1,6-hexanediol, polyethylene glycol, glycerin, ethanol, or a combination thereof.

14. The unit dose product of claim 1, wherein the detergent composition further comprises at least one additive selected from an anti-redeposition agent, an enzyme, a bleaching agent, a bleach activator, a chelating agent, an additional chlorine scavenger, a biocide, an optical brightener, a bitterant, a corrosion inhibitor, and a combination thereof.

15. The unit dose product of claim 1, wherein the detergent composition comprises about 5 to about 20 wt % water, a total of about 35 to about 65 wt % surfactants comprising at least one anionic surfactant and at least one nonionic surfactant, at least one amino acid or salt thereof, a base, a non-aqueous solvent comprising an alcohol, a polyol, or a combination thereof, and optionally a biocide, an optical brightener, a chelant, a corrosion inhibitor, and/or a bitterant.

16. The unit dose product of claim 15, wherein the detergent composition comprises about 5 to about 10 wt % water,
a total of about 40 to about 55 wt % surfactants selected from at least one surfactant selected from sodium lauryl sulfate, a linear alkyl benzene sulfonate, an alcohol ethoxysulfate, a methyl ester sulfonate, a fatty alcohol ethoxylate, an alkoxylated methyl ester of fatty acid, and coco fatty acid,
lysine or a salt thereof,
a base comprising a Group I hydroxide or monoethanolamine, and
a non-aqueous solvent comprising glycerin, propylene glycol, polyethylene glycol, and ethanol.

17. The unit dose product of claim 16, wherein the fatty alcohol ethoxylate is a C₁₂-C₁₅ fatty alcohol ethoxylate with 7 moles of ethoxylate.

18. The unit dose product of claim 1, wherein the detergent composition scavenges chlorine to a concentration of 0 ppm in less than about 60 sec after contact with a 1 L water sample comprising up to 4 ppm chlorine.

19. The unit dose product of claim 18, wherein the detergent composition scavenges chlorine to a concentration of 0 ppm in less than about 30 sec after contact with a 1 L water sample comprising up to 4 ppm chlorine.

20. The unit dose product of claim 1, wherein the water-soluble film material comprises polyvinyl alcohol (PVOH) or polyvinyl acetate (PVA).
